(19) United States
(12) Patent Application Publication
(10) Pub. No.: US 2009/0115593 A1
(43) Pub. Date: May 7, 2009

(54) VEHICULAR WARNING SYSTEM AND METHOD

(75) Inventors: LOUIS A. AVALLONE, MILFORD, MI (US); XUAN T. AVALLONE, MILFORD, MI (US); CLARK E. MC CALL, ANN ARBOR, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/934,542

(22) Filed: Nov. 2, 2007

(51) Int. Cl. B60Q 1/26

(52) U.S. Cl. 340/468

(57) ABSTRACT

Systems and methods are provided for warning a driver of a first motor vehicle that it is approaching a second motor vehicle. One system includes a processor coupled to a detector and an alarm device. The processor is in cooperation with the detector to determine a speed of the first vehicle and to activate the alarm device if the speed at which the first vehicle is approaching the second vehicle is greater than a predetermined speed. Another system includes means for determining a speed the first motor vehicle is approaching the second motor vehicle and means for warning the driver of the first motor vehicle if the speed is greater than the threshold speed. A method includes detecting a speed that the first motor vehicle is approaching the second motor vehicle and transmitting a warning to the first motor vehicle driver if the speed is greater than a threshold speed.

### TECHNICAL FIELD

The present invention generally relates to a warning system for motor vehicles, and more particularly relates to systems and methods for warning a first motor vehicle (e.g., a rear motor vehicle) that it is approaching a second motor vehicle (e.g., a leading motor vehicle) too rapidly.

### BACKGROUND OF THE INVENTION

It has long been a safety design goal to provide systems that alert drivers of neighboring vehicles to dangers that they might not otherwise be aware of. For example, modern vehicles are provided with turn signals that give notice to neighboring drivers of an impending turn. Hazard lights may be activated that warn neighboring drivers of road hazards, stalled vehicles, and the like. Brake lights warn drivers approaching from the rear that the brakes of a vehicle in front have been activated and the vehicle is slowing, perhaps to a stop. Unfortunately, unless a driver happens to be viewing traffic approaching from the rear (e.g. utilizing rear-view and/or side-view mirrors), the driver may not be able to take any affirmative action to warn, (as for example by tapping the brake pedal to illuminate the brake lights) a driver approaching from the rear that he is approaching at an excessive speed.

Accordingly, it may be desirable to provide systems and methods for automatically warning the driver of a motor vehicle that it is approaching another vehicle too rapidly. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

Various exemplary embodiments of the invention provide a system for warning a driver of a first motor vehicle that it is approaching a second motor vehicle. One system comprises a detector that monitors a predetermined region for the presence of the first motor vehicle and an alarm device. The system also comprises a processor coupled to the detector and the alarm device, wherein the processor is in cooperation with the detector to determine a speed of the first motor vehicle and to activate the alarm device if the speed at which the first motor vehicle is approaching the second motor vehicle is greater than a predetermined speed.

Another system comprises means for determining a speed at which a first motor vehicle is approaching a second motor vehicle, wherein the determining means is coupled to the first motor vehicle. The system also comprises means for warning the driver of the first motor vehicle if the speed is greater than the threshold speed, wherein the warning means is coupled to the determining means.

Methods are provided for warning a driver of a first motor vehicle that it is approaching a second motor vehicle too rapidly. One method comprises the steps of detecting a speed at which the first motor vehicle is approaching the second motor vehicle and transmitting a warning to the driver of the first motor vehicle if the speed is greater than a threshold speed.

### DESCRIPTION OF THE DRAWINGS

The present invention will hereinafter be described in conjunction with the following drawing figures, wherein like numerals denote like elements, and

FIG. 1 is a schematic diagram of a motor vehicle comprising one exemplary embodiment of a system for automatically warning the driver that it is approaching another motor vehicle too quickly;

FIG. 2 is a chart containing exemplary warnings that may be provided to a trailing motor vehicle when the motor vehicle of FIG. 1 is braking;

FIG. 3 is a flow diagram of an exemplary embodiment of a method for warning the driver of a trailing motor vehicle that he/she is approaching a leading motor vehicle at a rate greater than a threshold rate;

FIG. 4 is a flow diagram of another exemplary embodiment of a method for warning the driver of a trailing motor vehicle that he/she is approaching a leading vehicle too quickly; and

FIG. 5 is a flow diagram of yet another exemplary embodiment of a method for warning the driver of a trailing motor vehicle that he/she is approaching a leading vehicle too quickly.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

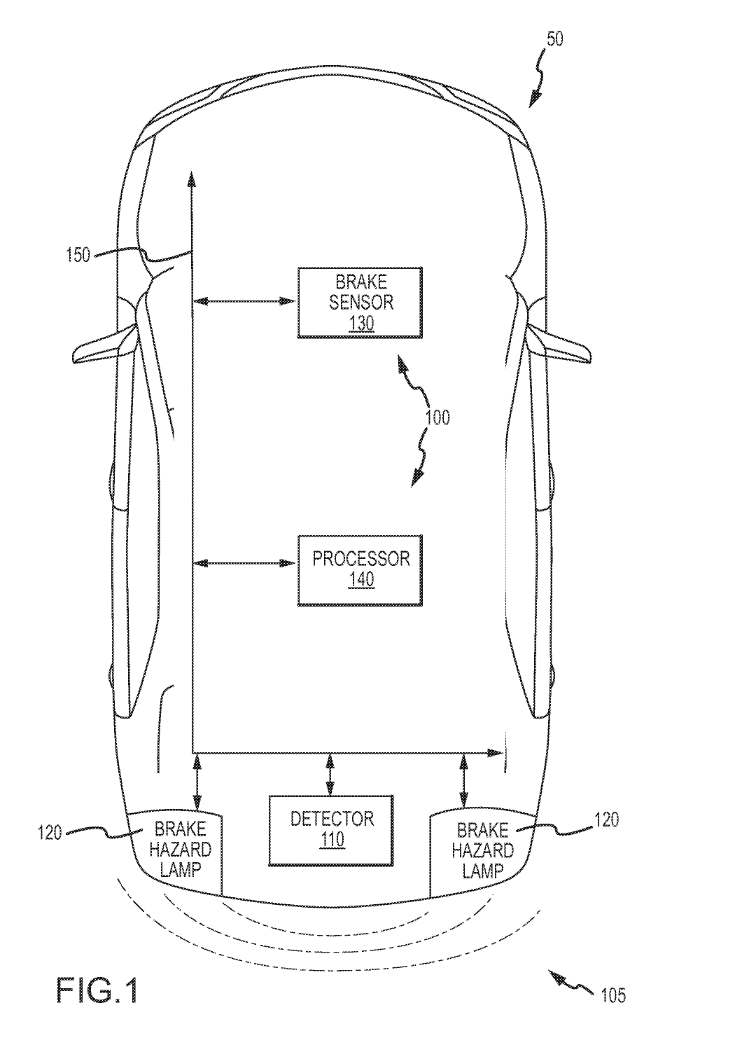

FIG. 1 is a schematic diagram of a motor vehicle 50 comprising a system 100 for automatically warning the driver of a rear or trailing motor vehicle that their vehicle is approaching a leading motor vehicle 50 at a speed greater than a threshold speed. System 100 comprises a detector 110, a warning device 120 (e.g. a brake/hazard lamp), a sensor 130, and a processor 140. Each of these elements is coupled together via a bus 150.

Detector 110 may be any device, hardware, and/or software capable of detecting the presence of one or more objects (e.g., another motor vehicle) in an area 105 behind motor vehicle 50 and the rate of approach of any such objects. In one exemplary embodiment, detector 110 may be a radio detection and ranging (RADAR) system. In other embodiments, detector 110 may comprise a laser detection and ranging (LADAR) system, a light detection and ranging (LIDAR) system, a camera system (e.g., a video camera, a 3-dimensional three-dimensional (3D) imaging device, and/or a 3D time-of-flight (TOF) camera), or the like.

Warning device 120 may be any device capable of capturing the attention of the driver of other proximate vehicles. In accordance with one exemplary embodiment of the invention, warning device 120 is a light (e.g. a motor vehicle brake lamp and/or hazard lamp); however, it should be clear that other visual and/or audible alarms may be employed. These visual and/or audible alarms may generate one or more of a plurality of predetermined warning patterns.

Referring again to FIG. 1, warning device 120 may comprise a brake lamp that indicates that the leading motor vehicle 50 is braking even though it is in fact, not braking. In another example, warning device 120 may comprise a brake lamp and/or hazard lamp that flashes rapidly. In yet another example, warning device 120 may be a horn or other sound-producing device that is sufficiently loud to capture the attention of a driver that is approaching too quickly. In one exemplary embodiment, sensor 130 may be configured to detect a braking force (e.g., g-force) generated by the brakes of a motor vehicle. Sensors configured to detect acceleration and/or speed of the motor vehicle may also be employed.

Processor 140 is a device, hardware, and/or software configured to receive signals from detector 110 indicating the presence of a vehicle to the rear and also indicating the rate at which the vehicle is approaching. Processor 140 processes the received signals and actuates warning device 120 when predetermined conditions exist. In one embodiment, processor 140 is configured to actuate warning device 120 if a vehicle to the rear is detected and is approaching at a speed greater than a predetermined threshold (e.g., 5 to 10 meters/second).

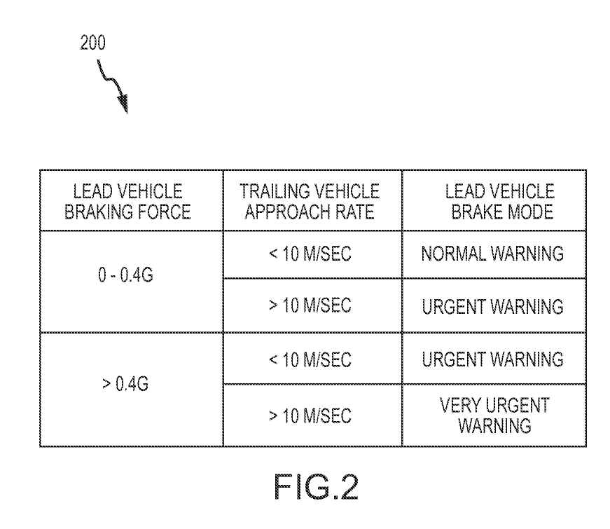

Processor 140 also receives signals indicative of braking force, acceleration, and/or speed of motor vehicle 50 from sensor 130 and processes these signals. Referring to the chart shown in FIG. 2, processor 140 is configured to command warning device 120 to provide a first or “normal” warning (e.g., brake lamps turn ON) if a motor vehicle is detected approaching motor vehicle 50 at a speed less than a predetermined threshold and sensor 130 detects that motor vehicle 50 is braking at a force less than a predetermined threshold force (e.g., less than about 0.4 g). Processor 140 may also command warning device 120 to provide a second or urgent warning (e.g., rapidly flashing brake lamps) if a vehicle is approaching at a speed greater than the predetermined threshold speed and sensor 130 detects that motor vehicle 50 is braking at a force less than the predetermined threshold force. Processor 140 may also command warning device 120 to provide the urgent warning if an object is approaching motor vehicle 50 at a speed less than the predetermined threshold speed and sensor 130 detects that the motor vehicle 50 is braking at a force greater than the threshold force. Similarly, processor 140 may command warning device 120 to provide a third or very urgent warning if an object is detected approaching motor vehicle 50 at a speed greater than the predetermined threshold speed and sensor 130 detects that motor vehicle 50 is braking at a force greater than the threshold force.

Although processor 140 has been discussed as being a separate and distinct component, it is contemplated that processor 140 may be integrated with detector 110, and/or that detector 110 may perform one or more of the operations discussed above with respect to processor 140.

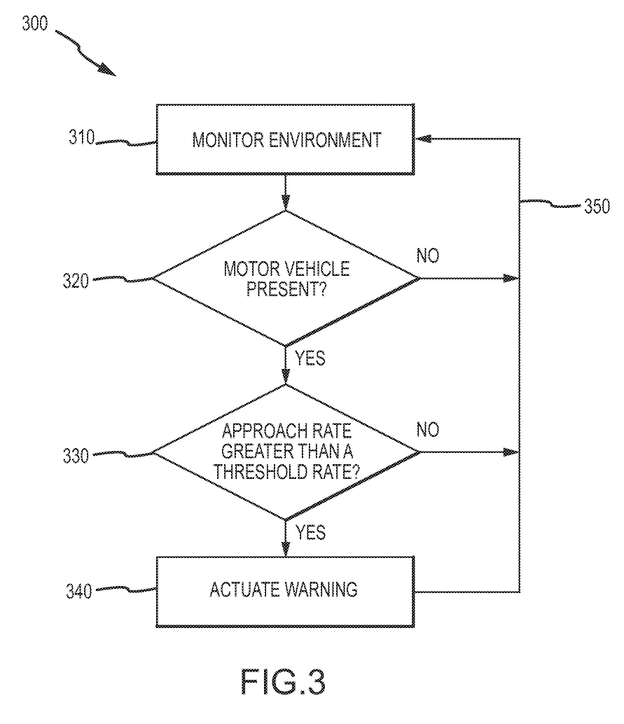

FIG. 3 is a flow diagram of a method 300 for warning the driver of another motor vehicle that he/she is approaching a motor vehicle (e.g., motor vehicle 50) too quickly. Method 300 begins with detector (e.g., detector 110) monitoring at least a portion of the environment surrounding motor vehicle 50 (step 310) to determine if a motor vehicle is present (step 320). If a motor vehicle is not detected, detector 110 continues to monitor the environment (step 350).

If a motor vehicle is detected, the speed at which the motor vehicle is approaching or closing in on motor vehicle 50 is calculated to determine if the motor vehicle is approaching at a speed greater than a threshold speed (step 330). In accordance with one exemplary embodiment, the threshold approach or closing speed is in the range of about 5 meters/second to about 10 meters/second. If the other motor vehicle is approaching at a rate less than the threshold speed, detector 110 continues to monitor the environment (step 350).

If the other motor vehicle is approaching at a rate greater than the threshold speed, a warning device (e.g., warning device 120) is actuated (step 340). The warnings transmitted by warning device 120 may be any of the warnings discussed above with reference to warning device 120 of FIG. 1. As illustrated in FIG. 3, after steps 320, 330, and 340 detector 110 continues to monitor the environment for other approaching motor vehicles and method 300 is repeated (step 350).

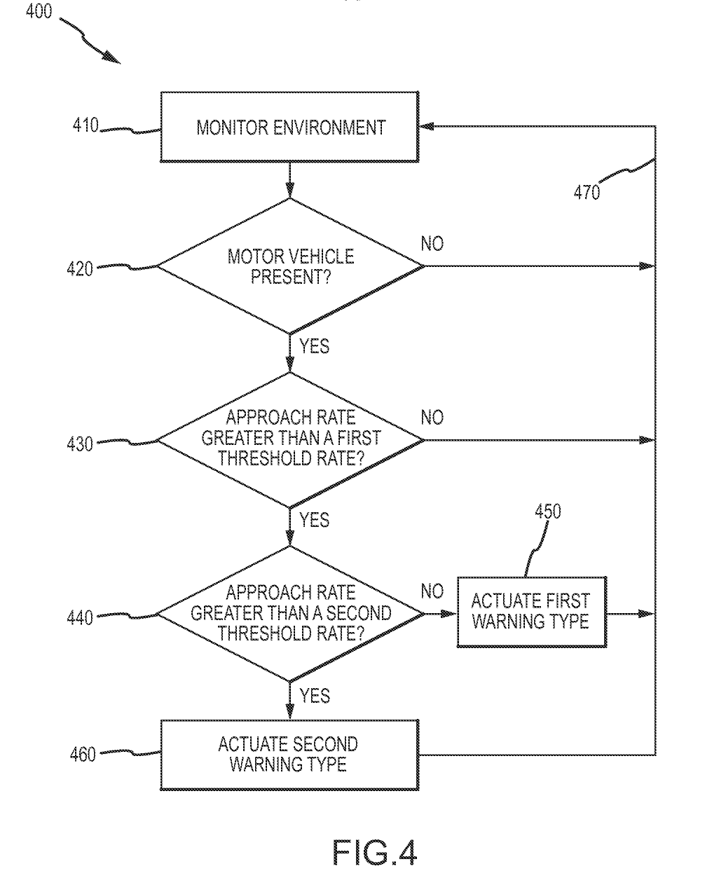

FIG. 4 is a flow diagram of another exemplary embodiment of a method 400 for warning the driver of another motor vehicle that he/she is approaching a motor vehicle (e.g., motor vehicle 50) too quickly. Method 400 begins with detector (e.g., detector 110) monitoring at least a portion of the environment surrounding motor vehicle 50 (step 410) to determine if a motor vehicle is present (step 420). If a motor vehicle is not detected, detector 110 continues to monitor the environment (step 470).

If a motor vehicle is detected, the speed at which the motor vehicle is approaching motor vehicle 50 is calculated to determine if the motor vehicle is approaching at a speed greater than a first threshold speed (step 430). If the other motor vehicle is approaching at a rate less than the first threshold speed, detector 110 continues to monitor the environment (step 470). If the other motor vehicle is approaching at a rate greater than the first threshold speed, it is then determined if the other motor vehicle is approaching at a rate greater than a second threshold rate of approach (step 440).

If the other motor vehicle is approaching motor vehicle 50 at a rate less than the second threshold rate but greater than the first threshold, a warning device (e.g., warning device 120) transmits a first warning (step 450). The first warning may be, for example, turning ON the brake lamps and/or hazard lamps of motor vehicle 50.

If the other motor vehicle is approaching motor vehicle 50 at a rate greater than the second threshold rate, the warning device transmits a second warning (step 460). The second warning may be, for example, rapidly flashing the brake lamps and/or hazard lamps of motor vehicle 50 or another more-urgent warning. As illustrated in FIG. 4, after steps 450 and 460 detector 110 continues to monitor the environment for other approaching motor vehicles and method 400 is repeated (step 470).

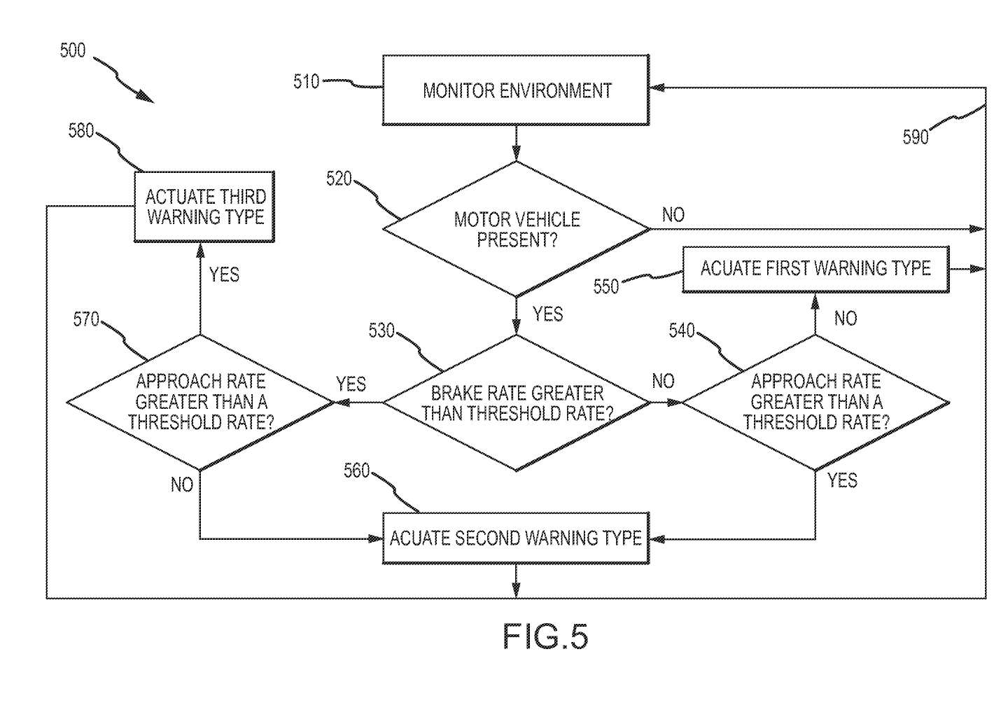

FIG. 5 is a flow diagram of a method 500 for warning the driver of another motor vehicle that he/she is approaching a motor vehicle (e.g., motor vehicle 50) too quickly. Method 500 begins with detector (e.g., detector 110) monitoring at least a portion of the environment surrounding motor vehicle 50 (step 510) to determine if a motor vehicle is present (step 520). If motor vehicle is not detected, detector 110 continues to monitor the environment (step 590).

If a motor vehicle is detected, the rate at which motor vehicle 50 is braking is calculated to determine if motor vehicle 50 is braking at a rate greater than a threshold rate (step 530). In accordance with one exemplary embodiment, the threshold braking rate is about 5 m/sec².

When the braking rate of motor vehicle 50 is less than the threshold rate, the speed at which the motor vehicle is approaching motor vehicle 50 is calculated to determine if the other motor vehicle is approaching at a speed greater than a threshold speed (step 540). In accordance with one exemplary embodiment, the threshold speed is in the range of about 5 meters/second to about 10 meters/second.

If the other motor vehicle is approaching at a rate less than the threshold speed, a warning device (e.g., warning device 120) is commanded to actuate a first warning (step 550). In one embodiment, the first warning is turning ON the brake lamps of motor vehicle 50, although other warnings are contemplated by various embodiments of the invention.

If the other motor vehicle is approaching at a rate greater than the threshold speed while motor vehicle 50 is braking at a rate less the threshold braking rate, the warning device actuates a second warning (step 560). In one embodiment, the second warning is turning ON the brake lamps and the hazard lamps of motor vehicle 50, although other embodiments of the invention contemplate the use of other types of warnings.

When motor vehicle 50 is braking at a rate greater the threshold braking rate, the speed at which the other motor vehicle is approaching motor vehicle 50 is calculated to determine if the other motor vehicle is approaching at a speed greater than a threshold speed (step 570). If the other motor vehicle is approaching at a rate less than the threshold speed, the warning device actuates the second warning (step 560).

If the other motor vehicle is approaching at a rate greater than the threshold speed, the warning device actuates a third warning (step 580). The third warning may be, for example, rapidly flashing the brake lamps and/or hazard lamps of motor vehicle 50 or some other type of visual and/or audible cue indicating a very urgent warning. As illustrated in FIG. 5, after each of steps 550, 560, and 580 detector 110 continues to monitor the environment for other approaching motor vehicles and method 500 is repeated (step 590).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. A system for warning a driver of a first motor vehicle that it is approaching a second motor vehicle, comprising:
a detector that monitors a predetermined region for the presence of the first motor vehicle;
an alarm device; and
a processor coupled to the detector and the alarm device to determine, in cooperation with the detector, a speed of the first motor vehicle and to activate the alarm device if the speed at which the first motor vehicle is approaching the second motor vehicle is greater than a predetermined speed.

2. The system of claim 1, wherein the alarm device is a brake lamp.

3. The system of claim 2, wherein the brake lamp is actuated in accordance with a predetermined pattern.

4. The system of claim 1, wherein the detector is a radio detection and ranging (RADAR) system,

5. The system of claim 1, wherein the detector is a camera.

6. The system of claim 1, wherein the detector is mounted on a rear portion of the second motor vehicle.

7. A system for warning a driver of a first motor vehicle that it is approaching a second motor vehicle at a speed greater than a threshold speed, comprising:
means for determining a speed at which the first motor vehicle is approaching the second motor vehicle, the determining means coupled to the second motor vehicle; and
means, coupled to the determining means, for warning the driver if the speed is greater than the threshold speed.

8. The system of claim 7, wherein the warning is a brake lamp.

9. The system of claim 7, wherein the determining means is a laser detection and ranging (LADAR) system.

10. The system of claim 7, wherein the determining means is a light detection and ranging (LIDAR) system.

11. The system of claim 7, wherein the determining means is an ultrasonic sensor.

12. A method for automatically warning a first motor vehicle that it is approaching a second motor vehicle too rapidly, the method comprising the steps of:
detecting a speed at which the first motor vehicle is approaching the 5 second motor vehicle; and
transmitting a first warning to the first motor vehicle if the speed is greater than a first threshold speed.

13. The method of claim 12, wherein the transmitting step comprises the step of activating an alarm on the second motor vehicle.

14. The method of claim 13, wherein activating the alarm comprises the step of activating a brake lamp.

15. The method of claim 14, wherein activating the alarm comprises the step of activating the brake lamp according to a predetermined pattern.

16. The method of claim 12 wherein the detecting step comprises electromagnetically detecting the speed the first motor vehicle is approaching the second motor vehicle.

17. The method of claim 12, further comprising the step of transmitting a second warning to the first motor vehicle if the speed is greater than a second threshold speed.

18. The method of claim 12, further comprising the steps of:
determining a braking rate of the second motor vehicle; and
transmitting the first warning to the first motor vehicle if the braking rate is greater than a threshold braking rate.

19. The method of claim 18, further comprising the step of transmitting a second warning to the first motor vehicle if the braking rate is less than the braking threshold rate and if the speed is less than the first threshold speed.

20. The method of claim 18, further comprising the step of transmitting a third warning to the first motor vehicle if the braking rate is greater than the threshold braking rate and the speed is greater than the first threshold speed.
